(19) United States
(12) Patent Application Publication
(10) Pub. No.: US 2025/0124264 A1
(43) Pub. Date: Apr. 17, 2025

(54) GENERATING CUSTOMIZED CONTENT DESCRIPTIONS USING ARTIFICIAL INTELLIGENCE

(71) Applicant: Google LLC, Mountain View, CA (US)

(72) Inventors: David M. Wang, Long Island City, NY (US); Gaurav Gupta, Dublin, CA (US); Gokhan Mergen, Los Gatos, CA (US); Baixu Chen, Sunnyvale, CA (US); Kumar Avinava Dubey, Palo Alto, CA (US); Amr Ahmed, Mountain View, CA (US)

(21) Appl. No.: 18/826,393

(22) Filed: Sep. 6, 2024

Related U.S. Application Data
(60) Provisional application No. 63/544,543, filed on Oct. 17, 2023.

(51) Int. Cl. G06N 3/0475; G06F 40/166; G06F 40/284; G06F 40/30; G06F 40/40; G06N 3/096

(52) U.S. Cl. CPC G06N 3/0475; G06F 40/166; G06F 40/284; G06F 40/30; G06F 40/40; G06N 3/096

(57) ABSTRACT

Methods, systems, and apparatus, including computer programs encoded on a computer storage medium, for generating descriptions of digital components. In one aspect, a method includes receiving data indicating a query received from a client device of a user. An initial digital component is obtained. Search history data that includes a set of related past queries received from the user is obtained. Updated text related to the first resource is generated by conditioning a language model with one or more contextual inputs that cause the language model to generate one or more outputs that include the updated text, the one or more contextual inputs characterizing one or more of the first query, data related to the initial digital component, the sequence of related past queries, or one or more tasks to be performed by the language model. An updated digital component that depicts the updated text is generated and provided.

### CROSS-REFERENCE TO RELATED APPLICATION

This application claims priority to U.S. Provisional Patent Application No. 63/544,543, filed on Oct. 17, 2023, the disclosure of which is hereby incorporated by reference in its entirety and for all purposes.

### TECHNICAL FIELD

This specification relates to data processing, artificial intelligence, and providing digital resource descriptions in response to user queries.

### BACKGROUND

Advances in machine learning are enabling artificial intelligence to be implemented in more applications. For example, large language models have been implemented to allow for a conversational interaction with computers using natural language rather than a restricted set of prompts. This allows for a more natural interaction with the computer.

### SUMMARY

This specification describes methods, computer systems, and apparatus, including computer programs encoded on computer storage media, for generating content descriptions based on user queries.

In general, one innovative aspect of the subject matter described in this specification can be embodied in methods that include the actions of receiving data indicating a first query received from a client device of a user; obtaining an initial digital component (i) including a link to a first resource and (ii) depicting initial text related to the first resource; obtaining search history data including a set of related past queries received from the user; generating updated text related to the first resource by conditioning a language model with one or more contextual inputs that cause the language model to generate one or more outputs including the updated text, the one or more contextual inputs characterizing one or more of (i) the first query, (ii) data related to the initial digital component, (iii) the sequence of related past queries, or (iv) one or more tasks to be performed by the language model; generating an updated digital component that depicts the updated text; and providing, for display at the client device, the updated digital component depicting the updated text related to the first resource. Other implementations of this aspect include corresponding apparatus, systems, and computer programs, configured to perform the aspects of the methods, encoded on computer storage devices.

These and other embodiments can each optionally include one or more of the following features. In some aspects, the one or more contextual inputs specify a format of the updated text as including a headline representing a title and a predefined number of bullet points providing information about the first resource.

In some aspects, the one or more tasks include a first task of generating a textual critique of the initial digital component.

In some aspects, the one or more tasks include a second task of generating a textual summary of user intent. The one or more contextual inputs can specify that the textual summary of the user intent is to be generated conditioned on (i) the current query and (ii) the sequence of related past queries.

In some aspects, the one or more tasks include a third task of generating a textual summary of content of the resource. The one or more tasks can include a fourth task of generating the updated text. The one or more contextual inputs can specify that the updated text is to be generated conditioned at least on the user intent predicted by performing the second task. The one or more contextual inputs can specify that the updated text is to be generated further conditioned on content of the first resource.

In some aspects, the one or more tasks include a fifth task of generating a textual explanation of why the updated digital component was provided to the user in response to the component request. Some aspects include providing the textual explanation to the client device for display.

In some aspects, the related past queries are selected from a set of queries that were received from the user within a specified time frame preceding the current query.

Some aspects include determining, for each respective query in a set of past queries received from the user, a similarity metric measuring a respective similarity between the respective query and the current query and selecting the related past queries based on the respective similarity metrics of the set of past queries. The similarity metric can include a salient term similarity that measures a similarity between two queries based on shared salient terms or keywords.

Some aspects include storing outputs generated by the language model based on additional search history data of a set of users; in response to receiving the current query and related past queries from a particular user, searching the stored outputs to identify an output generated for a similar query history; and generating the updated digital component based on the identified output.

Some aspects include, before generating the updated text related to the first resource, training the language model using a set of examples, wherein each example specifies at least (i) a training current query, (ii) a training set of past queries and (iii) a training digital component comprising text related to a resource. A first example in the set of examples further specifies one or more performance metrics of the training digital component.

In some aspects, the language model is a first language model that has been trained using outputs generated by a second language model, wherein the second language model has a larger number of parameters than the first language model.

In some aspects, generating the updated text related to the first resource includes comparing the first query and the set of related past queries to clusters of queries, wherein each cluster of queries corresponds to updated text for the initial digital component; determining that a respective similarity between the first query and the set of related past queries and each cluster of queries does not satisfy a threshold; and generating the updated text in response to determining that the respective similarity between the first query and the set of related past queries and each cluster of queries does not satisfy the threshold.

In some aspects, the data related to the digital component includes one or more of text depicted by the digital component, a description of the digital component, or text of a resource linked to be the digital component.

In some aspects, the language model is trained by distilling a larger language model.

Particular embodiments of the subject matter described in this specification can be implemented so as to realize one or more of the following advantages. A search engine can respond to a user's search query with a search results page that displays links, e.g., represented by Uniform Resource Locator (URL), to a number of relevant electronic resources, such as web pages. The search results page can further display one or more digital components that are relevant to the search query. For example, the search results page can display a digital component related to an item adjacent to the search results, at the top of the search results page, inline with the search results (e.g., as a special search result), and/or in other areas of a search results page. The digital component can include a link to an electronic resource (e.g., a landing page with content related to the item), text related to the item or electronic resource, and/or an image or video related to the item or electronic resource. In general, the text can be selected to convey essential information about the electronic resource and/or encourage a user to access the electronic resource for further information. In some cases, the text is provided by the content provider of the digital component, e.g., as part of the digital component itself. In some implementations, the search system can customize the text of the digital component to the user's current query. However, a single query from the user may not fully represent the intent of the user's search, resulting in text descriptions that do not address the user's actual interests, goals, or informational needs.

The techniques described herein can be used to generate electronic resource descriptions that are customized to the individual user's interests and needs, which can lead to a more informative and engaging experience for the user. In particular, the provided techniques can use language models, e.g., large language models (LLMs), or other trained machine learning models to analyze the context (e.g., as indicated in previous related user queries) of the current user query, and generate updated resource descriptions that take into account the latent intent of the user that is reflected by the queries but may not be stated in the queries, resulting in more accurate and pertinent descriptions of the relevant resources.

In some implementations of the provided techniques, in response to a user's search query, the system conditions a pre-trained language model on contextual inputs that specify one or more tasks (e.g., a series of tasks) to be performed by the language model to guide the language model to understand and perform aspects of the task of generating the updated (and improved) text related to the resource. The tasks can include, for example, evaluating the digital component in the context of the current query and the past queries (e.g., by generating a textual critique of the initial digital component with respect to the context), generating a textual summary of user intent taking into account the current query and the past queries, generating a textual summary of the content of the resource and/or the digital component, generating the updated text related to the resource (e.g., using one or both textual summaries) and/or generating an explanation for why the digital component is appropriate for (or otherwise why the digital component is being presented to) the user in any order or combination. By performing one or more of these tasks, the language model is effectively guided to generate improved text (e.g., textual description) of the resource that's better customized to the user's intent. This enables the language model to provide accurate and relevant text of a resource tailored to the user's intent, which enables the user to navigate to the proper resource and satisfy their informational needs faster, e.g., with fewer queries and fewer search results. This reduces the resources needed to perform the functions related to sending queries between devices over a network, identifying resources in response to the queries, identifying digital components related to the queries, generating search results and a search results page, and sending the search results and the digital components between devices.

Aggregated over millions of client devices of users, this results in substantial computational savings for the search system (e.g., reduced processor cycles and memory storage requirements) and the client devices, reduced network bandwidth consumption, and battery savings for mobile devices. For example, providing relevant digital components that link to relevant resources and that depict text that is customized to inform the user of content at the resource that the user is likely to be interested in can encourage the user to interact with (e.g., select) the digital component and navigate to the relevant resource to satisfy their informational needs without submitting any additional queries or having to navigate to many different resources before arriving at a resource that satisfies their informational needs.

For example, as the amount of text that can be depicted by a digital component is limited, using the same text for all users may not inform users as to all of the content that is available at a particular electronic resource. Using the described techniques, the search system can identify the most relevant content of the electronic resource for that user and inform the user of that content using updated text depicted by a digital component provided to that user. Learning the user's intent over multiple related queries, which can span multiple user sessions with the search system, enables the search system to more accurately determine the user's intent and display text that guides the user to relevant content without the user having to navigate to multiple resources to find such content. This results in the computational savings described above.

Further, in some implementations, the system uses a larger language model to train a smaller language model to generate the updated text that is depicted by digital components. The smaller language model has much fewer parameters than the larger language model, but it is given access to the text generated by the larger language model for performing the specified tasks as training data. This allows the smaller language model to achieve comparable performance to the larger language model for performing particular tasks using substantially fewer computational resources. For example, the smaller model requires less memory to store its weights and biases, and it requires much fewer operations to perform the specified tasks. As a result, the smaller model can generate high-quality updated text of the resource in real time, e.g., within milliseconds of receiving user queries. This enables the models to be used to generate customized text in response to queries where search results are typically provided in milliseconds.

When latency causes delays in providing digital components, undesirable behavior at a client device can result. For example, a delay responding to a request can result in page load errors at the client device or cause portions of the electronic resource to remain unpopulated even after other portions of the electronic resource are presented at the client device. Also, as the delay in providing the digital component to the client device increases, it is more likely that the electronic resource will no longer be presented at the client device when the digital component is delivered to the client device, thereby negatively impacting a user's experience with the electronic resource. Further, delays in providing the digital component can result in a failed delivery of the digital component, for example, if the electronic resource is no longer presented at the client device when the digital component is provided. Using smaller models as described herein enables the text to be generated and the digital components with the customized text to be provided to client devices in milliseconds, preventing such errors and negative impact on user experience.

In some implementations, pre-processing techniques can be used to reduce latency in providing customized digital components that include customized text. Sequences of queries can be evaluated using a language model to generate customized text for the digital components using an offline process. Each sequence of queries can be referred to as a cluster having customized text for the digital component that was generated using this offline process. When a query is received from a client device, the search system can compare the user's queries to the queries of each cluster and identify the cluster having queries most similar to the user's queries (or the same as the user's queries) and provide the digital component with the customized text for that most similar cluster. In this way, the processing performed using the language model may not be performed between the time a query is received and the time at which the digital component is provided, which reduces latency introduced by the language model for at least some of the queries received by the system. This can also enable the use of larger language models having more parameters, which can generate more relevant text than smaller models that user fewer parameters.

Furthermore, the techniques described herein provide a particular use of artificial intelligence (AI) to solve the problem of limited text space in digital components, such as search result descriptions, by generating customized content that aligns with the user's intent (e.g., the user's specific informational needs). In digital environments where space is constrained (e.g., search result snippets), it is important to present the most relevant information. The described technique leverages AI technology and, in some implementations large language models (LLMs), to generate targeted descriptions that prioritize the user's latent intent, derived from both current and past queries. This allows for optimal utilization of limited text space, ensuring that the most relevant content is displayed within the constraints of a digital component. By tailoring content to individual needs, rather than relying on generic descriptions, the described techniques represent an advancement in addressing the technical challenge of presenting information effectively within limited display areas.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example environment in which generative artificial intelligence can be implemented.

FIG. 2 illustrates interactions between a search system, a text generative model, and a client device.

FIG. 3A is a flow chart of an example process of generating text related to a resource using artificial intelligence.

FIG. 3B is a flow chart of an example process of training a language model to generate the updated text in response to a user query.

FIG. 4 is a block diagram of an example computer.

Like reference numbers and designations in the various drawings indicate like elements.

### DETAILED DESCRIPTION

This specification describes techniques for enabling artificial intelligence to generate customized descriptions of resources based on a user's intent reflected by multiple queries received from a user. Artificial intelligence (AI) is a segment of computer science that focuses on the creation of intelligent agents that can learn and act autonomously (e.g., with little or no human intervention). Artificial intelligence systems can utilize one or more of (i) machine learning, which focuses on developing algorithms that can learn from data, (ii) natural language processing, which focuses on understanding and generating human language, and/or (iii) computer vision, which is a field that focuses on understanding and interpreting images and videos. Artificial intelligence systems can include generative models that generate new content (e.g., text, images/video, audio, or other content) in response to input prompts.

The techniques described throughout this document enable AI to predict a user's intent based on user search history, and provide descriptions of one or more relevant resources identified by a search system that match the user's intent. For example, the search system can receive a user query and identify resources related to the query. The search system can generate search results for the identified resources and display the search results on a search results page. In addition, the search system can interact with an AI subsystem to identify a digital component and customize the text description that is depicted by the digital component based on the query and other queries received from the user. For example, the AI subsystem can select an initial digital component that includes a link to a resource relevant to the query and that depicts initial text related to the resource. The system can further obtain search history data specifying a sequence of past queries received from the user. The AI subsystem can select, from among the past queries, those that are related to the current query for use in generating the text description for the digital component.

An AI subsystem of the search system can generate updated text related to the resource using a generative language model based on the related past queries, which can be in the form of a sequence in which the queries were received, and the initial text related to the resource. In particular, the AI subsystem can utilize one or more prompts to condition the generative language model to perform one or more generative tasks. The tasks can include, for example, evaluating the digital component in the context of the current query and the past queries (e.g., by generating a textual critique of the initial digital component with respect to the context), generating a textual summary of user intent taking into account the current query and the past queries, generating a textual summary of the content of the resource and/or the digital component, generating the updated text related to the resource (e.g., using one or both textual summaries), and/or generating an explanation for why the digital component is appropriate for (or otherwise why the digital component is being presented to) the user in any order or combination.

The AI subsystem can use a chain or prompts for two or more of these actions and use the output(s) of one or more prompts as part of subsequent prompts in the chain to generate the text description. By conditioning the generative language model on the prompts, the AI subsystem can enhance the digital components and improve the quality of the text generated for the resource that better aligns with the user's intent. For example, the generated text can describe particular aspects of an item that is more relevant to the user's intent than generic text for the item.

As discussed in more detail below, the prompts are designed in a manner that guides the generative language model to understand and perform important aspects of the task with specified parameters. This enables the generative language model to provide accurate and relevant text related to a resource tailored to the user's intent, which enables the user to navigate to the proper resource and satisfy their informational needs faster, e.g., with fewer queries and fewer search results. This reduces the resources needed to perform these functions.

As used throughout this document, the phrase “digital component” refers to a discrete unit of digital content or digital information (e.g., a video clip, audio clip, multimedia clip, gaming content, image, text, bullet point, artificial intelligence output, language model output, or another unit of content). A digital component can electronically be stored in a physical memory device as a single file or in a collection of files, and digital components can take the form of video files, audio files, multimedia files, image files, or text files and include advertising information, such that an advertisement is a type of digital component.

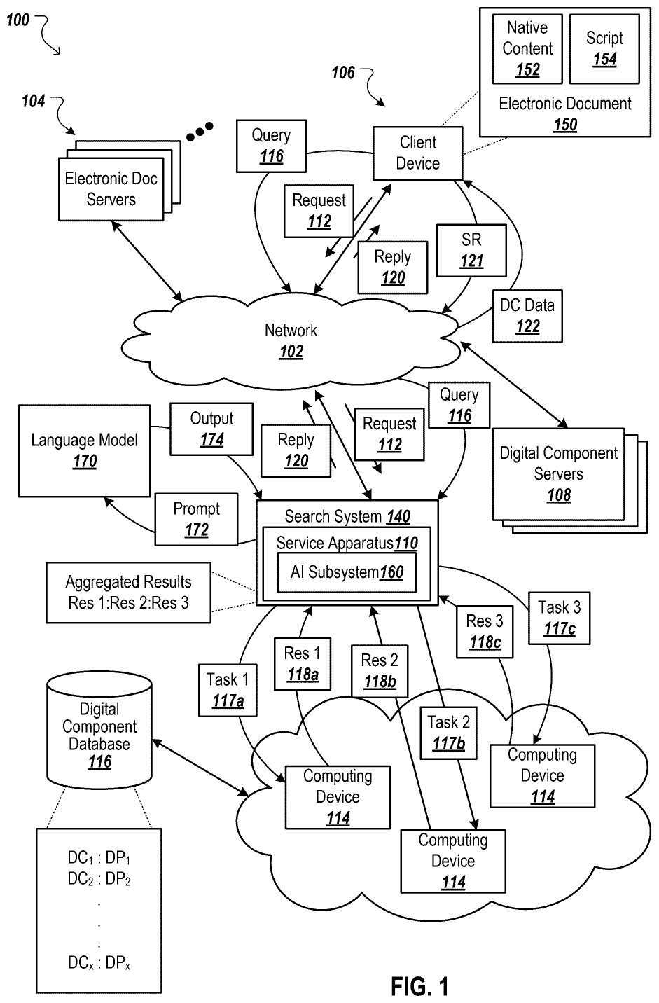

FIG. 1 is a block diagram of an example environment 100 in which generative artificial intelligence can be implemented. The example environment 100 includes a network 102, such as a local area network (LAN), a wide area network (WAN), the Internet, or a combination thereof. The network 102 connects electronic document servers 104, client devices 106, digital component servers 108, and a search system 140, which can include a service apparatus 110. The example environment 100 may include many different electronic document servers 104, client devices 106, and digital component servers 108.

A client device 106 is an electronic device capable of requesting and receiving online resources over the network 102. Example client devices 106 include personal computers, gaming devices, mobile communication devices, digital assistant devices, augmented reality devices, virtual reality devices, and other devices that can send and receive data over the network 102. A client device 106 typically includes a user application, such as a web browser, to facilitate the sending and receiving of data over the network 102, but native applications (other than browsers) executed by the client device 106 can also facilitate the sending and receiving of data over the network 102.

A gaming device is a device that enables a user to engage in gaming applications, for example, in which the user has control over one or more characters, avatars, or other rendered content presented in the gaming application. A gaming device typically includes a computer processor, a memory device, and a controller interface (either physical or visually rendered) that enables user control over content rendered by the gaming application. The gaming device can store and execute the gaming application locally, or execute a gaming application that is at least partly stored and/or served by a cloud server (e.g., online gaming applications). Similarly, the gaming device can interface with a gaming server that executes the gaming application and “streams” the gaming application to the gaming device. The gaming device may be a tablet device, mobile telecommunications device, a computer, or another device that performs other functions beyond executing the gaming application.

Digital assistant devices include devices that include a microphone and a speaker. Digital assistant devices are generally capable of receiving input by way of voice, responding with content using audible feedback, and presenting other audible information. In some situations, digital assistant devices also include a visual display or are in communication with a visual display (e.g., by way of a wireless or wired connection). Feedback or other information can also be provided visually when a visual display is present. In some situations, digital assistant devices can also control other devices, such as lights, locks, cameras, climate control devices, alarm systems, and other devices that are registered with the digital assistant device.

As illustrated, the client device 106 is presenting an electronic document 150, which is also referred to herein as an electronic resource or a resource. An electronic document is data that presents a set of content at a client device 106. Examples of electronic documents include webpages, word processing documents, portable document format (PDF) documents, images, videos, search results pages, and feed sources. Native applications (e.g., “apps” and/or gaming applications), such as applications installed on mobile, tablet, or desktop computing devices, and the content (e.g., app pages) displayed by the applications are also examples of resources. Electronic documents can be provided to client devices 106 by electronic document servers 104 (“Electronic Doc Servers”).

For example, the electronic document servers 104 can include servers that host publisher websites. In this example, the client device 106 can initiate a request for a given publisher webpage, and the electronic server 104 that hosts the given publisher webpage can respond to the request by sending machine-executable instructions that initiate presentation of the given webpage at the client device 106.

In another example, the electronic document servers 104 can include app servers from which client devices 106 can download apps and/or content of apps. In this example, the client device 106 can download files required to install an app at the client device 106, and then execute the downloaded app locally (i.e., on the client device). Alternatively, or additionally, the client device 106 can initiate a request to execute the app, which is transmitted to a cloud server. In response to receiving the request, the cloud server can execute the application and stream a user interface of the application to the client device 106 so that the client device 106 does not have to execute the app itself. Rather, the client device 106 can present the user interface generated by the cloud server's execution of the app, and communicate any user interactions with the user interface back to the cloud server for processing.

Electronic documents can include a variety of content. For example, an electronic document 150 can include native content 152 that is within the electronic document 150 itself and/or does not change over time. Electronic documents can also include dynamic content that may change over time or on a per-request basis. For example, a publisher of a given electronic document (e.g., electronic document 150) can maintain a data source that is used to populate portions of the electronic document. In this example, the given electronic document can include a script, such as the script 154, that causes the client device 106 to request content (e.g., a digital component) from the data source when the given electronic document is processed (e.g., rendered or executed) by a client device 106 (or a cloud server). The client device 106 (or cloud server) integrates the content (e.g., digital component) obtained from the data source into the given electronic document to create a composite electronic document including the content obtained from the data source.

In some situations, a given electronic document (e.g., electronic document 150) can include a digital component script (e.g., script 154) that references the service apparatus 110, or a particular service provided by the service apparatus 110. In these situations, the digital component script is executed by the client device 106 when the given electronic document is processed by the client device 106. Execution of the digital component script configures the client device 106 to generate a request for digital components 112 (referred to as a “component request”), which is transmitted over the network 102 to the service apparatus 110. For example, the digital component script can enable the client device 106 to generate a packetized data request including a header and payload data. The component request 112 can include event data specifying features such as a name (or network location) of a server from which the digital component is being requested, a name (or network location) of the requesting device (e.g., the client device 106), and/or information that the service apparatus 110 can use to select one or more digital components, or other content, provided in response to the request. The component request 112 is transmitted, by the client device 106, over the network 102 (e.g., a telecommunications network) to a server of the service apparatus 110.

The component request 112 can include event data specifying other event features, such as the electronic document being requested and characteristics of locations of the electronic document at which a digital component can be presented. For example, event data specifying a reference (e.g., URL) to an electronic document (e.g., webpage) in which the digital component will be presented, available locations of the electronic documents that are available to present digital components, sizes of the available locations, and/or media types that are eligible for presentation in the locations can be provided to the service apparatus 110. Similarly, event data specifying keywords associated with the electronic document (“document keywords”) or entities (e.g., people, places, or things) that are referenced by the electronic document can also be included in the component request 112 (e.g., as payload data) and provided to the service apparatus 110 to facilitate identification of digital components that are eligible for presentation with the electronic document. The event data can also include a search query 116 that was submitted from the client device 106 to obtain a search results page.

Component requests 112 can also include event data related to other information, such as information that a user of the client device has provided, geographic information indicating a state or region from which the component request was submitted, or other information that provides context for the environment in which the digital component will be displayed (e.g., a time of day of the component request, a day of the week of the component request, a type of device at which the digital component will be displayed, such as a mobile device or tablet device). Component requests 112 can be transmitted, for example, over a packetized network, and the component requests 112 themselves can be formatted as packetized data having a header and payload data. The header can specify a destination of the packet and the payload data can include any of the information discussed above.

The service apparatus 110 chooses digital components (e.g., third-party content, such as video files, audio files, images, text, gaming content, augmented reality content, and combinations thereof, which can all take the form of advertising content or non-advertising content) that will be presented with the given electronic document (e.g., at a location specified by the script 154) in response to receiving the component request 112 and/or using information included in the component request 112.

In some implementations, a digital component is selected in less than a second to avoid errors that could be caused by delayed selection of the digital component. For example, delays in providing digital components in response to a component request 112 can result in page load errors at the client device 106 or cause portions of the electronic document to remain unpopulated even after other portions of the electronic document are presented at the client device 106.

Also, as the delay in providing the digital component to the client device 106 increases, it is more likely that the electronic document will no longer be presented at the client device 106 when the digital component is delivered to the client device 106, thereby negatively impacting a user's experience with the electronic document. Further, delays in providing the digital component can result in a failed delivery of the digital component, for example, if the electronic document is no longer presented at the client device 106 when the digital component is provided.

In some implementations, the service apparatus 110 is implemented in a distributed computing system that includes, for example, a server and a set of multiple computing devices 114 that are interconnected and identify and distribute digital components in response to requests 112. The set of multiple computing devices 114 operate together to identify a set of digital components that are eligible to be presented in the electronic document from among a corpus of millions of available digital components (DC₁₋ₓ). The millions of available digital components can be indexed, for example, in a digital component database 116. Each digital component index entry can reference the corresponding digital component and/or include distribution parameters (DP₁-DPₓ) that contribute to (e.g., trigger, condition, or limit) the distribution/transmission of the corresponding digital component. For example, the distribution parameters can contribute to (e.g., trigger) the transmission of a digital component by requiring that a component request include at least one criterion that matches (e.g., either exactly or with some pre-specified level of similarity) one of the distribution parameters of the digital component.

In some implementations, the distribution parameters for a particular digital component can include distribution keywords that must be matched (e.g., by electronic documents, document keywords, or terms specified in the component request 112) in order for the digital component to be eligible for presentation. Additionally, or alternatively, the distribution parameters can include embeddings that can use various different dimensions of data, such as website details and/or consumption details (e.g., page viewport, user scrolling speed, or other information about the consumption of data). The distribution parameters can also require that the component request 112 include information specifying a particular geographic region (e.g., country or state) and/or information specifying that the component request 112 originated at a particular type of client device (e.g., mobile device or tablet device) in order for the digital component to be eligible for presentation. The distribution parameters can also specify an eligibility value (e.g., ranking score, or some other specified value) that is used for evaluating the eligibility of the digital component for distribution/transmission (e.g., among other available digital components).

The identification of the eligible digital component can be segmented into multiple tasks 117a-117c that are then assigned among computing devices within the set of multiple computing devices 114. For example, different computing devices in the set 114 can each analyze a different portion of the digital component database 116 to identify various digital components having distribution parameters that match the information included in the component request 112. In some implementations, each given computing device in the set 114 can analyze a different data dimension (or set of dimensions) and pass (e.g., transmit) results (Res 1-Res 3) 118a-118c of the analysis back to the service apparatus 110. For example, the results 118a-118c provided by each of the computing devices in the set 114 may identify a subset of digital components that are eligible for distribution in response to the component request and/or a subset of the digital components that have certain distribution parameters. The identification of the subset of digital components can include, for example, comparing the event data to the distribution parameters, and identifying the subset of digital components having distribution parameters that match at least some features of the event data.

The service apparatus 110 aggregates the results 118a-118c received from the set of multiple computing devices 114 and uses information associated with the aggregated results to select one or more digital components that will be provided in response to the request 112. For example, the service apparatus 110 can select a set of winning digital components (one or more digital components) based on the outcome of one or more content evaluation processes, as discussed below. In turn, the service apparatus 110 can generate and transmit, over the network 102, reply data 120 (e.g., digital data representing a reply) that enable the client device 106 to integrate the set of winning digital components into the given electronic document, such that the set of winning digital components (e.g., winning third-party content) and the content of the electronic document are presented together at a display of the client device 106.

In some implementations, the client device 106 executes instructions included in the reply data 120, which configures and enables the client device 106 to obtain the set of winning digital components from one or more digital component servers 108. For example, the instructions in the reply data 120 can include a network location (e.g., a Uniform Resource Locator (URL)) and a script that causes the client device 106 to transmit a server request (SR) 121 to the digital component server 108 to obtain a given winning digital component from the digital component server 108. In response to the request, the digital component server 108 will identify the given winning digital component specified in the server request 121 (e.g., within a database storing multiple digital components) and transmit to the client device 106, digital component data (DC Data) 122 that presents the given winning digital component in the electronic document at the client device 106.

When the client device 106 receives the digital component data 122, the client device 106 will render the digital component (e.g., third-party content), and present the digital component at a location specified by, or assigned to, the script 154. For example, the script 154 can create a walled garden environment, such as a frame, that is presented within, e.g., beside, the native content 152 of the electronic document 150. In some implementations, the digital component is overlayed over (or adjacent to) a portion of the native content 152 of the electronic document 150, and the service apparatus 110 can specify the presentation location within the electronic document 150 in the reply 120. For example, when the native content 152 includes video content, the service apparatus 110 can specify a location or object within the scene depicted in the video content over which the digital component is to be presented.

The search system 140 is configured to generate and provide search results in response to queries 116 received from client devices 106 of users. To facilitate searching of resources, the search system 140 can crawl publisher web sites and index the resources provided by the web sites. In response to receiving a query from a client device 106, the search system 140 can use the index to identify resources that are relevant to the query and return search results to the client device 106. A search result is data generated by the search system 140 that identifies a resource that satisfies a particular search query, and includes a resource locator for the resource. An example search result can include a web page title, a snippet of text extracted from the resource, and the URL of the web page.

As an example, the search system 140 can receive a query 116 from the client device 106. The query can be one or more search terms provided by the user. The search system 140 can provide a set of search results for resources identified in response to the query 116 for display on the client device 106. The search system 140 can also provide digital components for display with the search results displayed in a search results page. The search system 140 can include the service apparatus 110. In some implementations, the search system 140 and the service apparatus can be separate. For example, the search system 140 can submit a request to the service apparatus 110 for digital components, receive the digital components from the service apparatus 110, and provide the digital components to the client device 106 with the search results.

The search system 140 can also include an artificial intelligence (“AI”) subsystem 160 configured to autonomously generate and/or update digital components, either prior to a request 112 (e.g., offline) and/or in response to a request 112 (e.g., online or real-time). As described in more detail throughout this specification, the AI subsystem 160 can collect online content about a specific entity (e.g., digital component provider or another entity) and autonomously summarize the collected online content (e.g., a webpage or another online resource) using one or more language models 170, which can include large language models. The AI subsystem 160 can also use the language models 170 to generate updated text, e.g., updated text descriptions, for digital components.

A large language model (“LLM”) is a model that is trained to generate and understand human language. LLMs are trained on massive datasets of text and code, and they can be used for a variety of tasks. For example, LLMs can be trained to translate text from one language to another; summarize text, such as web site content, search results, news articles, or research papers; answer questions, such as “What is the capital of Georgia?”; create chatbots that can have conversations with humans; and generate creative text, such as poems, stories, and code.

The language model 170 can be any appropriate language model neural network that receives an input sequence made up of text tokens selected from a vocabulary and auto-regressively generates an output sequence made up of text tokens from the vocabulary. For example, the language model 170 can be a Transformer-based language model neural network or a recurrent neural network-based language model.

In some situations, the language model 170 can be referred to as an auto-regressive neural network when the neural network used to implement the language model 170 auto-regressively generates an output sequence of tokens. More specifically, the auto-regressively generated output is created by generating each particular token in the output sequence conditioned on a current input sequence that includes any tokens that precede the particular text token in the output sequence, i.e., the tokens that have already been generated for any previous positions in the output sequence that precedes the particular position of the particular token, and a context input that provides context for the output sequence.

For example, the current input sequence when generating a token at any given position in the output sequence can include the input sequence and the tokens at any preceding positions that precede the given position in the output sequence. As a particular example, the current input sequence can include the input sequence followed by the tokens at any preceding positions that precede the given position in the output sequence. Optionally, the input and the current output sequence can be separated by one or more predetermined tokens within the current input sequence.

More specifically, to generate a particular token at a particular position within an output sequence, the neural network of the language model 170 can process the current input sequence to generate a score distribution, e.g., a probability distribution, that assigns a respective score, e.g., a respective probability, to each token in the vocabulary of tokens. The neural network of the language model 170 can then select, as the particular token, a token from the vocabulary using the score distribution. For example, the neural network of the language model 170 can select the highest-scoring token or can sample, e.g., using nucleus sampling or another sampling technique, a token from the distribution.

As a particular example, the language model 170 can be an auto-regressive Transformer-based neural network that includes (i) a plurality of attention blocks that each apply a self-attention operation and (ii) an output subnetwork that processes an output of the last attention block to generate the score distribution.

The language model 170 can have any of a variety of Transformer-based neural network architectures. Examples of such architectures include those described in J. Hoffmann, S. Borgeaud, A. Mensch, E. Buchatskaya, T. Cai, E. Rutherford, D. d. L. Casas, L. A. Hendricks, J. Welbl, A. Clark, et al. Training compute-optimal large language models, arXiv preprint arXiv:2203.15556, 2022; J. W. Rae, S. Borgeaud, T. Cai, K. Millican, J. Hoffmann, H. F. Song, J. Aslanides, S. Henderson, R. Ring, S. Young, E. Rutherford, T. Hennigan, J. Menick, A. Cassirer, R. Powell, G. van den Driessche, L. A. Hendricks, M. Rauh, P. Huang, A. Glaese, J. Welbl, S. Dathathri, S. Huang, J. Uesato, J. Mellor, I. Higgins, A. Creswell, N. McAleese, A. Wu, E. Elsen, S. M. Jayakumar, E. Buchatskaya, D. Budden, E. Sutherland, K. Simonyan, M. Paganini, L. Sifre, L. Martens, X. L. Li, A. Kuncoro, A. Nematzadeh, E. Gribovskaya, D. Donato, A. Lazaridou, A. Mensch, J. Lespiau, M. Tsimpoukelli, N. Grigorev, D. Fritz, T. Sottiaux, M. Pajarskas, T. Pohlen, Z. Gong, D. Toyama, C. de Masson d'Autume, Y. Li, T. Terzi, V. Mikulik, I. Babuschkin, A. Clark, D. de Las Casas, A. Guy, C. Jones, J. Bradbury, M. Johnson, B. A. Hechtman, L. Weidinger, I. Gabriel, W. S. Isaac, E. Lockhart, S. Osindero, L. Rimell, C. Dyer, O. Vinyals, K. Ayoub, J. Stanway, L. Bennett, D. Hassabis, K. Kavukcuoglu, and G. Irving. Scaling language models: Methods, analysis & insights from training gopher. CoRR, abs/2112.11446, 2021; Colin Raffel, Noam Shazeer, Adam Roberts, Katherine Lee, Sharan Narang, Michael Matena, Yanqi Zhou, Wei Li, and Peter J Liu. Exploring the limits of transfer learning with a unified text-to-text transformer. arXiv preprint arXiv:1910.10683, 2019; Daniel Adiwardana, Minh-Thang Luong, David R. So, Jamie Hall, Noah Fiedel, Romal Thoppilan, Zi Yang, Apoorv Kulshreshtha, Gaurav Nemade, Yifeng Lu, and Quoc V. Le. Towards a human-like open-domain chatbot. CoRR, abs/2001.09977, 2020; and Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.

Generally, however, the Transformer-based neural network includes a sequence of attention blocks, and, during the processing of a given input sequence, each attention block in the sequence receives a respective input hidden state for each input token in the given input sequence. The attention block then updates each of the hidden states at least in part by applying self-attention to generate a respective output hidden state for each of the input tokens. The input hidden states for the first attention block are embeddings of the input tokens in the input sequence and the input hidden states for each subsequent attention block are the output hidden states generated by the preceding attention block.

In this example, the output subnetwork processes the output hidden state generated by the last attention block in the sequence for the last input token in the input sequence to generate the score distribution.

Generally, because the language model is auto-regressive, the service apparatus 110 can use the same language model 170 to generate multiple different candidate output sequences in response to the same request, e.g., by using beam search decoding from score distributions generated by the language model 170, using a Sample-and-Rank decoding strategy, by using different random seeds for the pseudo-random number generator that's used in sampling for different runs through the language model 170 or using another decoding strategy that leverages the auto-regressive nature of the language model.

In some implementations, the language model 170 is pre-trained, i.e., trained on a language modeling task that does not require providing evidence in response to user questions, and the service apparatus 110 (e.g., using AI subsystem 160) causes the language model 170 to generate output sequences according to the pre-determined syntax through natural language prompts in the input sequence.

For example, the service apparatus 110 (e.g., AI subsystem 160), or a separate training system, pre-trains the language model 170 (e.g., the neural network) on a language modeling task, e.g., a task that requires predicting, given a current sequence of text tokens, the next token that follows the current sequence in the training data. As a particular example, the language model 170 can be pre-trained on a maximum-likelihood objective on a large dataset of text, e.g., text that is publicly available from the Internet or another text corpus.

In some implementations, the AI subsystem 160 can submit one or more prompts 172 to the language model 170, and causes the language model 170 to generate an output 174 conditioned on the prompts 172. The prompts 172 can be constructed in a manner (e.g., having a structure) that specifies a set of constraints the language model must use to generate the output 174.

The prompts 172 specify one or more generative tasks to be performed by the language model 170. For example, the prompts 172 can specify a task for the language model 170 to generate a textual summary of user intent based on a sequence of past queries received by the user. The prompts 172 can specify a task for the language model 170 to generate updated text related to a resource conditioned at least on the textual summary of the user intent.

For example, the language model 170 can be used to generate updated text for a digital component based on queries received from a user. The service apparatus 110 can update a selected digital component with the updated text and provide the updated digital component to the client device 106 of the user.

Note that, although the operations of the AI subsystem 160 and language model 170 are described above as being performed responsive to receipt of the request 112, at least some of the operations can be performed prior to receipt of the request 112 in some implementations.

Furthermore, although a single language model 170 is shown in FIG. 1, different language models can be specially trained to process different prompts at different stages of the processing pipeline. For example, a more general (e.g., larger) language model can be used to generate the summaries of online content as an offline process (e.g., independent of receipt of the request 112), which can then be inserted into prompts that are input to a more specialized and faster language model in an online process (e.g., real-time in response to receiving the request 112). Additionally, the AI subsystem 160 can generate a set of candidate digital components as an offline process (e.g., prior to receiving the request 112, and store the set of candidate digital components in a database. In this scenario, when the AI subsystem 160 receives the request 112, the AI subsystem 160 can further evaluate and select from the stored candidate digital components based on additional information included in the request and other contextual data (e.g., time of day, day of week, weather conditions, etc.).

In another example, a language model 170 can be used to generate, for a digital component, updated text for clusters of queries. For example, each cluster can include multiple queries and the queries can optionally be arranged in a sequence in which the queries are received. In this example, the language model 170 can be used to generate updated text for each cluster in an offline process. During an online process, the service apparatus 110 can identify the cluster that is most similar to the user's queries and provide to the user the digital component with the text of the identified cluster. In this way, latency in providing a digital component can be reduced by avoiding the use of the language model 170 in the online process. If none of the clusters are sufficiently similar to the user's queries, the language model 170 can be used to generate the updated text for the digital component. Thus, using clusters can reduce the latency for at least some of the digital components that are sent to client devices 106 and preserve the use of the language model 170 for sequences of queries that do not match sufficiently with the clusters. The queries of a cluster can be queries received from client devices 106, queries input by an administrator of the search system 140, or by a machine learning model.

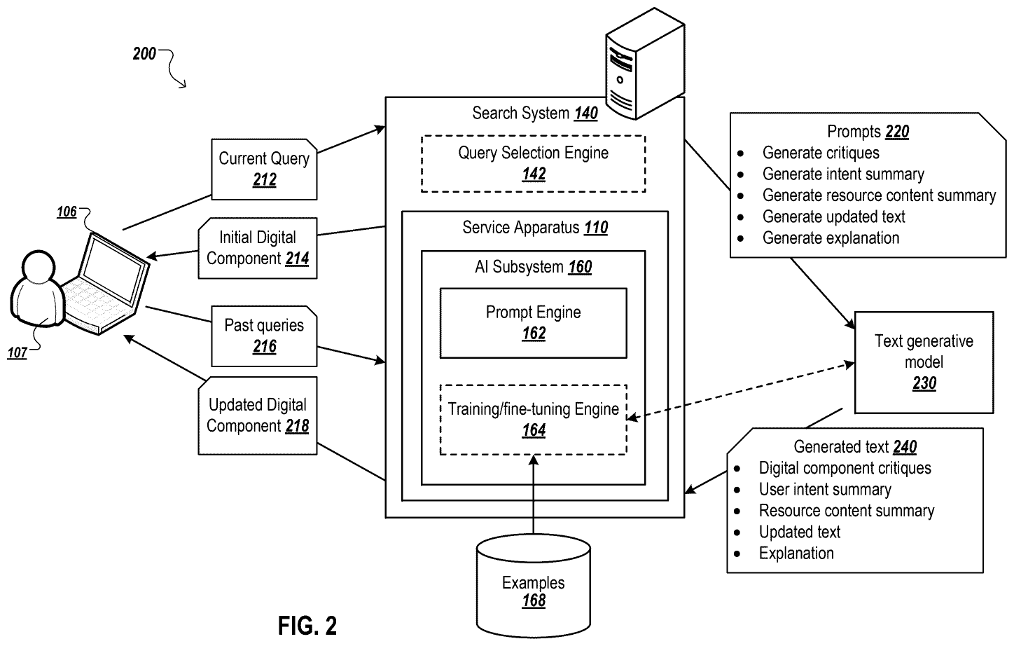

FIG. 2 is a block diagram 200 illustrating interactions between the search system 140, a text generative model 230, and the client device 106 of a user 107. The text generative model 230 can be a language model, e.g., the language model 170 of FIG. 1. Other machine learning models can also be used.

The search system 140 is implemented using at least one computing device (e.g., including one or more processors). The search system 140 includes the AI subsystem 160 and can include additional optional components. The following description refers to different components of the search system 140 as being implemented independently and each configured to perform a set of operations, but any of these components could be combined to perform the operations discussed below.

The search system 140 receives a current query 212 from the client device 106 of the user 107. The current query 212 can include one or more search terms that are provided by the user 107. For example, the current query 212 can include a specific set of words, phrases, or questions used to articulate the user's informational needs.

The search system 140 can identify a set of resources that include content that satisfies the current query, e.g., including information that is relevant to the current query. The search system 140 can identify the resources from among a corpus of millions of available resources, e.g., webpages. The search system 140 can provide, e.g., for display in a user interface of the client device 106, a search result that includes links to the identified resources. The search system 140 further provides an initial digital component 214 that includes a link to a resource and text related to the resource. The link of a resource can be a hyperlink that directs the client device 106 to the resource. A digital component can include other content, as described herein.

The search system 140 can provide the search results for display on a search results page shown at the client device 106. For example, the client device 106 can display the search results within the search results page. The displayed search results can be ordered according to the relevancy of their resources to the initial query and/or based on other criteria. The search system 140 can also provide the initial digital component 214 for display on the search results page shown at the client device 106. For example, the client device 106 can display the initial digital component 214 (including the link to the resource and the text related to the resource) at the top of the search results page, between adjacent search results, to one side of the search results page, or in another appropriate location.

The search system 140 can be configured to obtain the initial digital component from the service apparatus 110. For example, the search system 110 can provide, to the service apparatus 110, the current query 212, past queries of the user, and/or other data that can be used to select a digital component as described herein. The service apparatus 110 can select the initial digital component 214 using the received data and update the initial digital component, and provide the updated digital component to the search system 140.

The text related to the resource of the initial digital component 214 can be a summary, an introduction, a description, and/or one or more highlights of the resource to which the initial digital component is linked. In some examples, the text can include an excerpt of content included in the content of the resource. In some cases, the text is provided by the content provider of the resource. In some other cases, the search system 140 can customize, e.g., by using a generative language model, the text to the user's current query. The text aims to convey essential information about the electronic resource and encourage the user to access the electronic resource for further details. However, text provided by the content provider or customized to a single current query may not fully address the intent of the user for the search query.

To address the above limitation, the search system 140 further obtains data indicating past queries 216 from the user 107. In some implementations, the past queries can be queries submitted by the user within a specified time frame preceding the current query 212 (e.g., within 15 days, 30 days, three months, one year, or another time period preceding the current query 212). In some implementations, the past queries can be queries that precede the current query 212 within the same user session. The search system 140 can obtain the past query data from one or more sources, including, for example, the logs of the search system 140.

A user session can be defined by a start event and an end event. The start event can be the opening or launching of a search interface at the client device 106 or receipt of a first query from the client device 106. For example, the start event can be when the user navigates to a search interface provided in a web page or the opening of a native application that includes the search interface. The end event can be the closing of the search interface or a navigation from the web page that includes the search interface. The end event can also be based on a duration of time since a last query has been received. For example, the search system 140 can determine that a user session has ended if no queries are received from the client device 106 for at least a threshold period of time, e.g., five minutes, ten minutes, one hour, or another time period.

In some implementations, a query selection engine 142 of the search system 140 or another system can select a sequence of past queries from the user that are related to the current query 212. For example, the query selection engine 142 can select the sequence of past queries related to the current query 212 based on a similarity metric measuring a similarity between a respective past query and the current query 212, e.g., by only selecting past queries having the similarity metric that satisfies (e.g., meets or exceeds) a predefined threshold. The query selection engine 142 can use any appropriate similarity metric for selecting the related past queries. In one example, the query cluster (QC) similarity can be used as the metric, which measures the similarity between two query clusters computed as the average similarity between the queries in the two clusters. Another similarity metric that may be used is the salient term similarity, which measures the similarity between queries based on shared salient terms (e.g., important or prominent keywords).

After the search system 140 obtains the sequence of related past queries, the AI subsystem 160 can use the text generative model 230 to generate, based at least on the current query 212 and the sequence of related past queries, updated text related to the resource specified by the digital component 214. The updated text takes into account the user's intent indicated by the sequence of related past queries and/or the current query 212, and thus is more likely to align with the user's intent for the search. The search system 140 then provides, for display at the client device 106, an updated digital component 218 that includes the updated text related to the resource. For example, the service apparatus 110 can update the digital component by replacing initial text of the digital component with the updated text.

In an illustrating example, the current query 212 received from the client device can be “table top wood.” The initial digital component 214 corresponds to (and includes a link to) a resource (e.g., a hypothetical webpage with a URL “example.com/woodslabs”). In this example, the text related to the resource that is depicted by the initial digital component may be:

“Wood Slabs for Sale (example.com/woodslabs)
Featuring beautiful tables, desks, countertops, kitchen islands, dining tables and more
Huge selection of live edge parota (guanacaste), monkey pod. Stop in to find your slab
Looking for a unique one of a kind furniture piece? Striking furniture! Local craftsman.”

The above text related to the resource would have been informative to the user if the user intended to look for a wood table top to purchase. However, the user's search history may include a sequence of queries that include the current query 212 and the related past queries of:
“how to fill gaps in wood”→“how to make a table top without a jointer”→“how to glue up a table top”→“wood joints”→“how to get a matte finish with polyurethane” →“how to straighten a warped board”→“how to two tone stain wood”→“how to apply polyurethane.”

These past queries may indicate that the user intended to look for information and materials to make a wood table top. In this case, the initial text related to the resource may not be of interest to the user. The AI subsystem 160 aims to analyze the user's queries to predict the intent of the user, and update the text related to the identified resource to better align with the user's intent. In this example, the AI subsystem 160 can generate updated text related to constructing a table top based on the past queries.

In general, the AI subsystem 160 interacts with a text generative model 230 to generate the updated text. In some implementations, the text generative model 230 or a component of the text generative model 230 can be implemented as the language models 170 discussed above with reference to FIG. 1. The text generative model 230 is configured to receive one or more prompts 220 and generate one or more textual outputs 240 conditioned on the prompts 220. In general, a prompt for a generative language model is a specific input provided to the model to generate a desired response or output. For example, the prompt can be a piece of text that specifies a context (e.g., a contextual input) for conditioning the generative language model to generate the desired response.

In particular, a prompt engine 162 of the AI subsystem 160 can submit the prompts 220 to condition the text generative model 230 to perform a list of generative tasks, e.g., generating the outputs 240 (which include at least the updated text). The prompts 220 guide the text generative model 230 to understand and perform important aspects of the task of generating the updated (and improved) text related to the identified resource. The AI subsystem 160 can submit prompts 220 to the text generative model 230 in a sequence, which can be referred to as a prompt chain. In general, prompts submitted to the text generative model 230 can specify the current query, data related to the initial digital component, the sequence of related past queries, and/or one or more tasks to be performed by the language model. The data related to the digital component can include text depicted by the digital component, a description of the digital component, and/or text of a resource linked to be the digital component. The prompt engine 162 can submit the above contextual information (and/or other information) as a single prompt or a series of multiple prompts to the text generative model 230 to condition the model 230 for generating the outputs specified by the one or more tasks. Each prompt 220 can include one or more portions of the contextual information and/or information output by the text generative model 230 based on one or more other prompts 220.

In an example implementation, the prompts 220 submitted by the prompt engine 162 to the text generative model 230 specify a set of tasks including a first task for evaluating the digital component in the context of the current query and the past queries (e.g., by generating a textual critique of the initial digital component with respect to the context), a second task for generating a textual summary of user intent taking into account the current query and the past queries, a third task for generating a textual summary of the content of the resource and/or the digital component, a fourth task for generating the updated text related to the resource (e.g., using one or both textual summaries), and/or (v) a fifth task for generating an explanation for why the digital component is appropriate for (or otherwise why the digital component is being presented to) the user. The prompt engine 162 can generate prompts 220 for any combination of one or more of the tasks to generate the updated text for the digital component and/or an explanation for the digital component.

In general, at least one of the prompts 220 include the fourth task for the text generative model 230 to generate the updated text related to the resource. This allows the service apparatus 110 to update the text of the digital component based on the user's queries. A prompt 220 for the fourth task can include the current query, the sequence of related past queries, and the data related to the initial digital component. The prompt 220 can also include instructions that specify that the model 230 should generate the updated text based on the other information of the prompt.

In some implementations, the prompt for the fourth task can include information generated by the text generative model 230 based on prompts for the first task, the second task, and/or the third task in any order or combination. For example, the prompt engine 230 can submit, to the text generative model 230, a prompt 220 for the first task to obtain a textual critique of the initial digital component with respect to the context. This prompt 220 can include, for example, current query, data related to the initial digital component, and/or the sequence of related past queries. This 220 prompt can also include instructions for generating the textual critique.

Similarly, the prompt engine 230 can submit, to the text generative model 230, a prompt 220 for the second task to obtain textual summary of user intent. This prompt can include, for example, the current query, the sequence of related past queries, and instructions for generating the textual summary based on the other information of the prompt 220.

Similarly, the prompt engine 230 can submit, to the text generative model 230, a prompt 220 for the third task to obtain a textual summary of the content of the resource and/or the digital component. This prompt 220 can include the data related to the digital component (e.g., content of the resource linked to by the digital component) and instructions for generating the textual summary based on the other information of the prompt 220.

In this example, the prompt engine 162 can submit, to the text generative model 230, a prompt 220 that specifies that the model 230 should generate the updated text based on the textual critique, the textual summary of user intent, and/or the textual summary of the content of the resource and/or the digital component. By using the summary of user intent and/or the summary of the content to condition the text generative model 230, the AI subsystem 160 can reduce the size of the prompt for the subsequent tasks (e.g., generating the updated text for the digital component and/or the explanation) and allow the model 230 to generate broader outputs (rather than focusing on specific user queries). In addition, using the summary of the content in the prompt for the updated text and/or explanation can prevent “hallucinations” in the generated outputs—e.g., output content that is fictional, incorrect, misleading, or otherwise not grounded in factual or accurate information.

In some implementations, the AI subsystem 160 can determine whether to perform the subsequent tasks (e.g., generate the updated text and/or explanation) depending on the critique generated by the text generative model 230 for the initial digital component. For example, if the generated critique indicates that the initial digital component does not provide a meaningful answer to the current query or does not address the user intent demonstrated by the past user queries, the system can determine to not proceed to perform the subsequent tasks for generating the textual summary of user intent and generating the updated text related to the resource.

In some implementations, the service apparatus 110 can provide an explanation as to why the digital component is being presented to the user and/or why the updated text was included in the digital component. The explanation can be presented with the digital component. The prompt engine 162 can submit, to the text generative model 230, a prompt 220 that instructs the text generative mode 230 to generate the explanation. This prompt 220 can include, for example, the textual summary of user intent and/or the textual summary of the content of the resource and/or the digital component. The textual explanation provides the reasoning behind the updated digital component, which may further facilitate the user's decision whether to access the resource for further information (e.g., by clicking the link to the resource).

Although the prompts 220 for the tasks are largely described as being one prompt for each task above, a single prompt 220 can include instructions for any combination of the tasks.

The prompts 220 for any of the tasks described above can further specify one or more of the following:
a set of sources that should be used to generate the output;
details about the set of sources the model should consider when generating the output;
factual grounding instructions specifying that the model should provide citations to the sources used to generate the output;
constraints specifying information that should not be included in the output (e.g., information that is not directly supported by the set of sources);
formatting constraints specifying how the output should be formatted, e.g., as bullet points or in paragraph form, with or without a title or an introduction summary, and/or total length (e.g., number of words or separate clauses); and
tone constraints specifying a tone of the output, e.g., creative, funny, sad, serious, from the perspective of a specified entity, such as an artist, engineer, or story writer, or to a specified audience.

In an illustrating example, the prompts can take the form of:
“You are tasked to evaluate the quality of the relevance of a digital component to a given user session and rewrite the digital component description to capture the user intent. You are presented with a user's search_session (recent past queries entered by the user) the current_query, and the initial source description followed by the digital_component. The digital_component consists of three components: 1) vis_url: a domain shown to the user that will take them to the source landing page, 2) source_headline: A short headline that represents the title of the source, 3) source_description: 3 bullet points) that give more information about the source that is relevant to the given user session.

```
  Past user queries (search_session):
    <past query 1>
    <past query 2>
    . . .
    <past query N>
  current_query:
    <current query>
  search_result:
    resource_url: <source URL>
    resource_headline: <source headline>
    resource_description:
      <resource description 1>
      <resource description 2>
      <resource description 3>
search_result: <resource URL>
```

Task-1: Evaluate the relevance of the digital component to the current query and past user queries. Provide brief feedback.
Task-2: Summarize the user intent based on search_session and current_query.
Task-3: Read and summarize the content of digital_component.
Task-4 Create a revised source description that is more aligned with the user's intent and query. Explain the relevance of your revised description briefly.
Task5—Draft an explanation for the user on why this digital component was selected, emphasizing its relevance to their queries.”

The AI subsystem 160 can submit the above contextual inputs as a single prompt or a series of multiple prompts to the text generative model 230 to condition the model 230 for generating the outputs.

As shown in the above example, for the second task, the prompts 220 specify that the textual summary of the user intent is to be generated conditioned at least on the current query and the sequence of related past queries. For the fourth task, the prompts 220 specify that the updated text is to be generated conditioned on the user intent (as generated by performing the second task). Thus, in this example, the updated text takes into account the latent user intent inferred by the model 230 based on the user search history, and thus is likely better aligned with the user's interests and needs compared to the initial description. The prompts 220 can also specify that the updated text is to be generated further conditioned on the content of the resource (e.g., from the webpage of the resource).

The service apparatus 110 generates the updated digital component 218 based on the output 240 of the text generative model 230, and provides the updated digital component 218 to the client device 106 for display. The updated digital component 218 depicts the updated text related to the resource. In some implementations, the search system 140 further provides the textual explanation of the updated digital component (generated by the model 230 in response to task five specified in the prompts) to the client device for display. The textual explanation provides the reasoning behind the updated digital component, which may further facilitate the user's decision whether to access the resource for further information (e.g., by clicking the link to the resource).

In some implementations, the service apparatus 110 can use a caching technique to speed up the process of providing the updated digital component 218 for certain current and past queries. For example, the service apparatus 110 or another system can store outputs previously generated by the model 230 based on the search history data of a set of users. When the service apparatus 110 receives the current query and related past queries from a particular user, the service apparatus 110 can search the stored outputs to identify an output generated for a similar query history, and generate or obtain the updated digital component based on the identified output. In this way, the search system 140 may not have to use the text generative model 230 to generate updated text for each query.

In a particular example, the service apparatus 110 can maintain clusters of queries for each of one or more digital components. Each cluster for a digital component can include a sequence or list of queries and can include respective updated text for the digital component. When a query is received from a client device 106 of a user, the service apparatus 110 can compare the query and the sequence of related queries to the queries of each cluster. Based on the comparison, the service apparatus 110 can determine a similarity score for each cluster. The service apparatus 110 can compare the similarity scores to a threshold and, if the similarity score for a cluster satisfies (e.g., meets or exceeds) the threshold, the service apparatus 110 can generate the updated digital component using the updated text of that cluster. If the similarity scores of multiple clusters satisfies the threshold, the service apparatus 110 can use the updated text of the cluster having the highest similarity score. In some implementations, the service apparatus 110 can cache an updated digital component for each cluster such that the service apparatus 110 does not have to update the digital component at query time. Instead, the service apparatus 110 can simply identify the similar cluster and send the updated digital component for that cluster.

As discussed above, the text generative model 230 can be implemented as the language models 170, e.g., LLMs, that have been pre-trained on a large text corpus. In some implementations, a training/fine-turning engine 164 of the AI subsystem 160 or another system can perform additional training of the text generative model 230 on the particular tasks related to generating the updated text related to the resource based on the user search data. In particular, the training/fine-turning engine 164 performs training of the model 230 on a set of training examples 168. Each training example can define an example of performing the task of generating text related to a resource given the current and past search queries received from the user. For example, a training example can specify a training query, a training sequence of related past queries, and an example digital component including a link to a resource and text related to the resource. In some implementations, at least one of the training examples further specifies one or more performance metrics measuring the effectiveness of the example digital component. For example, the performance metrics can include a click-through rate (e.g., predicted or measured click-through rate) for the linked resource of the digital component, which estimates the likelihood of a user clicking on the link to the resource. In another example, the performance metrics can include a bid amount placed by the provider of the resource for displaying the training search result. The training/fine-turning engine 164 can adjust the model parameters of the model 230 based on the training examples using a supervised learning algorithm, e.g., by performing gradient descent through backpropagation of a loss function with respect to the model parameters.

Although a single text generative model 230 is depicted in FIG. 2, the text generative model 230 can include a set of different text generative models that are invoked to perform different tasks for which the different text generative models are specially trained. For example, one text generative model within the set of text generative models may be specially trained to perform the first task of generating a textual critique of the initial digital component, while another text generative model may be specially trained to perform the second task for generating a textual summary of user intent, a third text generative model may be specially trained to perform the third task of generating the textual summary of the content of the resource, a fourth text generative model may be specially trained to perform the fourth task of generating the updated text related to the resource, and a fifth text generative model may be specially trained to perform the fifth task for generating the textual explanation of why the updated digital component is appropriate in response to the query. Furthermore, the set of models can include a generalized text generative model that is larger is size, and capable of generating large amounts of diverse datasets, but this generalized text generative model may have higher latency than the specialized text generative models, which can make it less desirable for use in real-time operations, depending on time latency constraints required to generate content. Each text generative model can be implemented by way of an LLM, or another model that is configured to generate natural language text responsive to a prompt.

In some implementations, the training/fine-turning engine 164 can train the text generative model 230 using outputs generated by a different, e.g., a larger language model that has a greater number of parameters than the text generative model 230. The larger language model may be an LLM that has been pre-trained on a large text corpus, and optionally, has been fine-tuned with examples specific for the particular tasks related to generating the updated text for the resource based on the user search data. The training/fine-turning engine 164 provides the text generated by the larger language model for performing the specified tasks as training data to the text generative model 230. This allows the model 230 to achieve comparable performance to the larger language model for performing the particular tasks with much fewer computational resources. For example, the model 230 requires less memory to store its parameters, and it requires much fewer operations to generate the updated text. As a result, the model 230 can generate high-quality updated resource descriptions in real-time, e.g., within milliseconds of receiving user queries.

In one example, model distillation is used to generate the smaller model. Model distillation is a technique used in machine learning to transfer knowledge from a larger, more complex “teacher” model to a smaller and more lightweight “student” model. This approach is particularly useful when you have a large, accurate model, but you want to deploy a smaller and faster model with similar performance. The main idea is to train the student model to mimic the behavior or predictions of the teacher model.

A benefit of model distillation include model compression. For example, the student model is much smaller in terms of parameters and memory footprint than the teacher model, making it suitable for deployment in latency or compute constrained situations (e.g., with very large datasets). Another benefit of model distillation includes improved generalization. For example, the student model may generalize better than if it were trained from scratch because it benefits from the knowledge learned by the teacher model.

To generate a smaller model, the large teacher model can generate a number “N” examples to train the smaller student model. The teacher model is a large, complex model that has been trained on a large dataset and has achieved high performance on a particular task. It serves as the source of knowledge that we want to transfer to the student model. The teacher model can be a language model 170 described above.

The teacher model is used to generate a dataset of N examples. These examples can be in the form of input-output pairs, where data is input into the teacher model, and it provides predictions as outputs.

The student model is a smaller and simpler neural network that is typically easier to deploy in real-time applications or amenable to large scale compute. Typically a smaller language model, pretrained on a large corpus of text.

During training, the student model is trained to minimize a special loss function known as the distillation loss. The distillation loss is designed to encourage the student model to produce predictions that are not only accurate but also similar to the predictions made by the teacher model on the same inputs. The student model is trained using a combination of the distillation loss for the data coming from the teacher, optionally combined with a traditional loss function (e.g., cross-entropy) that measures its performance on its original training data.

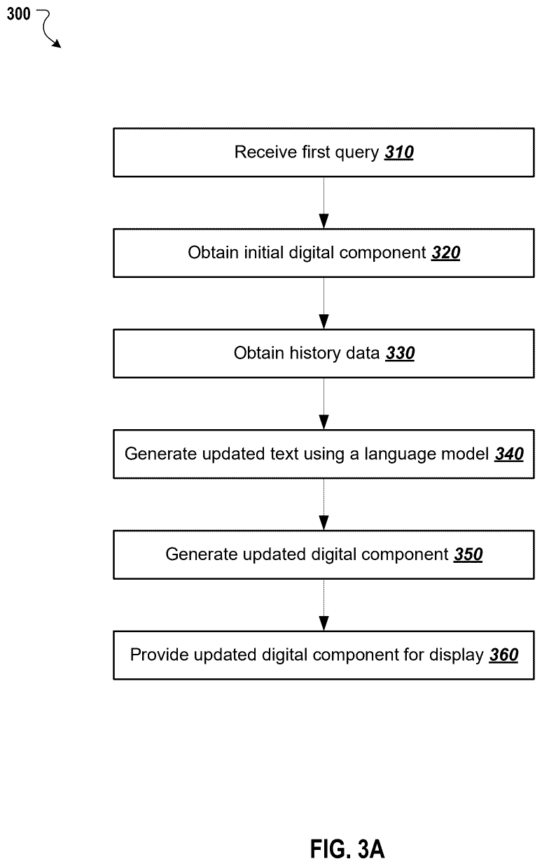

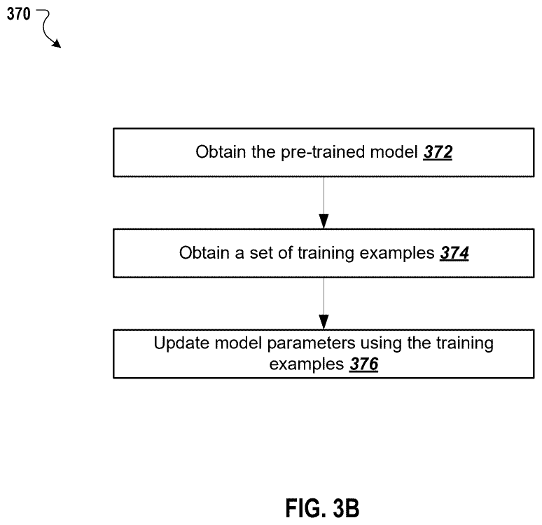

FIG. 3A is a flow diagram of an example process 300 for generating a resource description using artificial intelligence. Operations of the process 300 can be performed by a system of one or more computers located in one or more locations, e.g., the search system 140 described with references to FIG. 1 and FIG. 2, appropriately programmed in accordance with this specification. Operations of the process 300 can also be implemented as instructions stored on one or more computer-readable media, which may be non-transitory, and execution of the instructions by one or more data processing apparatus can cause the one or more data processing apparatus to perform the operations of the process 300. For convenience and without loss of generality, the process 300 will be described as being performed by a data processing apparatus, e.g., a computer system.

At 310, the system receives data indicating a current query received from a client device of a user. The current query can include one or more search terms. For example, the current query can include a specific set of words, phrases, or questions used to articulate the user's informational needs.

At 320, the system obtains an initial digital component that includes a link to a resource and depicts initial text related to the resource.

At 330, the system obtains search history data of the user. The search history data includes a set of past queries. In some implementations, the past queries can be queries submitted by the user within a specified time frame preceding the current query 212 (e.g., within 15 days, 30 days, three months, one year, or another time period preceding the current query 212). In some implementations, the past queries can be queries that precede the current query 212 within the same user session. The system can select, from the search history data, a set of past queries that are related to the current query. For example, the system can select the related past queries based on a similarity metric measuring a similarity between a respective query and the current query. The system can use any appropriate similarity metric for selecting the related past queries, such as the QC or the salient term similarity.

At 340, the system generates updated text related to the resource using a language model. In particular, the system conditions the language model with one or more contextual inputs, prompting the language model to generate one or more outputs including the updated text. The one or more contextual inputs can specify the current query, data related to the initial digital component, the sequence of related past queries, and/or one or more tasks to be performed by the language model. In general, the contextual inputs can further specify a format of the updated text. For example, the contextual inputs can specify that the updated text should include a headline and a predefined number of descriptors. These contextual inputs can be submitted to the language model as a single prompt or a series of multiple prompts to condition the language model for generating the outputs.

The tasks specified in the contextual inputs include at least a task for generating the updated text related to the resource. In some implementations, the contextual inputs can further specify a task for the language model to generate a textual summary of user intent based on the current query and the set of related past queries, and specify that the updated text is to be generated conditioned at least on the inferred summary of the user intent. By using the summary of user intent to condition the model 230, the system can reduce the size of the prompt for the subsequent tasks and allow the model 230 to generate broader outputs (rather than focusing on specific user queries). In some implementations, the contextual inputs can further specify a task for the language model to generate textual summary of the content of the resource (e.g., from the website of the resource), and specify that the updated text is to be generated further conditioned on content of the resource. In some implementations, the contextual inputs can further specify a task for the language model to generate a textual critique of the initial digital component. In some implementations, the contextual inputs can further specify a task for the language model to generate a textual explanation of why an updated digital component including the updated text is appropriate in response to the current query. The textual explanation provides the reasoning behind the updated digital component, which may further facilitate the user's decision whether to access the resource for further information (e.g., by clicking the link to the resource).

At 350, the system generates an updated digital component that depicts the updated text.

At 360, the system provides, for display at the client device, the updated digital component depicting the updated text related to the resource. In some cases, the system can further provide the textual explanation (generated by performing the fifth task) to the client device for display.

FIG. 3B is a flow diagram of an example process 370 for training the language model of FIG. 3A. Operations of the process 370 can be performed by a system of one or more computers located in one or more locations, e.g., the training/fine-tuning engine 164 of the search system 140 described with reference to FIG. 2, appropriately programmed in accordance with this specification. Operations of the process 370 can also be implemented as instructions stored on one or more computer-readable media, which may be non-transitory, and execution of the instructions by one or more data processing apparatus can cause the one or more data processing apparatus to perform the operations of the process 370. For convenience and without loss of generality, the process 370 will be described as being performed by a data processing apparatus, e.g., a computer system.

At 372, the system obtains a pre-trained language model that has been pre-trained on a text corpus.

At 374, the system obtains a set of training examples. Each training example can define an example of performing the task of generating text related to a resource given the current and past search queries received from the user. For example, a training example can specify (i) a training query, (ii) a training sequence of related past queries, and (iii) an example digital component including a link to a resource and text related to the resource.

In some implementations, at least one of the training examples further specifies one or more performance metrics measuring the effectiveness of the example digital component. For example, the performance metrics can include a click-through rate (e.g., predicted or measured click-through rate) for the linked resource of the digital component, which estimates the likelihood of a user clicking on the link to the resource. In another example, the performance metrics can include a bid amount placed by the provider of the resource for displaying the training search result.

At 376, the system adjusts the model parameters of the language model based on the training examples using a supervised learning algorithm, e.g., by performing gradient descent through backpropagation of a loss function with respect to the model parameters.

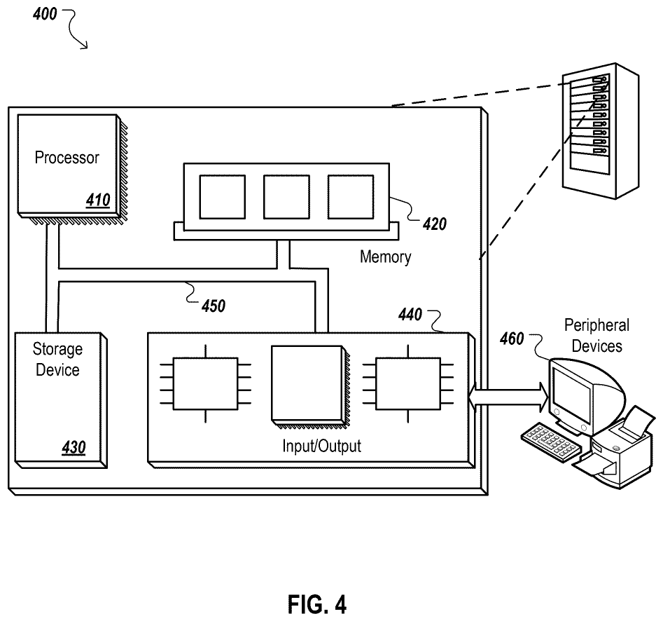

FIG. 4 is a block diagram of an example computer system 400 that can be used to perform operations described above. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (e.g., a cloud storage device), or some other large capacity storage device.

The input/output device 440 provides input/output operations for the system 400. In one implementation, the input/output device 440 can include one or more of network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other devices, e.g., keyboard, printer, display, and other peripheral devices 460. Other implementations, however, can also be used, such as mobile computing devices, mobile communication devices, set-top box television client devices, etc.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

For situations in which the systems discussed here collect and/or use personal information about users, the users may be provided with an opportunity to enable/disable or control programs or features that may collect and/or use personal information (e.g., information about a user's social network, social actions or activities, a user's preferences, or a user's current location). In addition, certain data may be treated in one or more ways before it is stored or used, so that personally identifiable information associated with the user is removed. For example, a user's identity may be anonymized so that the no personally identifiable information can be determined for the user, or a user's geographic location may be generalized where location information is obtained (such as to a city, ZIP code, or state level), so that a particular location of a user cannot be determined.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

This document refers to a service apparatus. As used herein, a service apparatus is one or more data processing apparatus that perform operations to facilitate the distribution of content over a network. The service apparatus is depicted as a single block in block diagrams. However, while the service apparatus could be a single device or single set of devices, this disclosure contemplates that the service apparatus could also be a group of devices, or even multiple different systems that communicate in order to provide various content to client devices. For example, the service apparatus could encompass one or more of a search system, a video streaming service, an audio streaming service, an email service, a navigation service, an advertising service, a gaming service, or any other service.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method, comprising:
receiving data indicating a first query received from a client device of a user;
obtaining an initial digital component (i) comprising a link to a first resource and (ii) depicting initial text related to the first resource;
obtaining search history data comprising a set of related past queries received from the user;
generating updated text related to the first resource by conditioning a language model with one or more contextual inputs that cause the language model to generate one or more outputs comprising the updated text, the one or more contextual inputs characterizing one or more of (i) the first query, (ii) data related to the initial digital component, (iii) the sequence of related past queries, or (iv) one or more tasks to be performed by the language model;
generating an updated digital component that depicts the updated text; and
providing, for display at the client device, the updated digital component depicting the updated text related to the first resource.

2. The method of claim 1, wherein the one or more contextual inputs specify a format of the updated text as comprising a headline representing a title and a predefined number of bullet points providing information about the first resource.

3. The method of claim 1, wherein the one or more tasks comprise a first task of generating a textual critique of the initial digital component.

4. The method of claim 1, wherein the one or more tasks comprise a second task of generating a textual summary of user intent.

5. The method of claim 4, wherein the one or more contextual inputs specify that the textual summary of the user intent is to be generated conditioned on (i) the current query and (ii) the sequence of related past queries.

6. The method of claim 4, wherein the one or more tasks comprise a third task of generating a textual summary of content of the resource.

7. The method of claim 6, wherein the one or more tasks comprise a fourth task of generating the updated text.

8. The method of claim 7, wherein the one or more contextual inputs specify that the updated text is to be generated conditioned at least on the user intent predicted by performing the second task.

9. The method of claim 8, wherein the one or more contextual inputs specify that the updated text is to be generated further conditioned on content of the first resource.

10. The method of claim 1, wherein the one or more tasks comprise a fifth task of generating a textual explanation of why the updated digital component was provided to the user in response to the component request.

11. The method of claim 10, further comprising providing the textual explanation to the client device for display.

12. The method of claim 1, further comprising:
determining, for each respective query in a set of past queries received from the user, a similarity metric measuring a respective similarity between the respective query and the current query; and
selecting the related past queries based on the respective similarity metrics of the set of past queries.

13. The method of claim 12, wherein the similarity metric comprises a salient term similarity that measures a similarity between two queries based on shared salient terms or keywords.

14. The method of claim 1, further comprising:
storing outputs generated by the language model based on additional search history data of a set of users;
in response to receiving the current query and related past queries from a particular user, searching the stored outputs to identify an output generated for a similar query history; and
generating the updated digital component based on the identified output.

15. The method of claim 14, further comprising, before generating the updated text related to the first resource, training the language model using a set of examples, wherein each example specifies at least (i) a training current query, (ii) a training set of past queries and (iii) a training digital component comprising text related to a resource.

16. The method claim 1, wherein the language model is a first language model that has been trained using outputs generated by a second language model, wherein the second language model has a larger number of parameters than the first language model.

17. The method of claim 1, wherein generating the updated text related to the first resource comprises:
comparing the first query and the set of related past queries to clusters of queries, wherein each cluster of queries corresponds to updated text for the initial digital component;
determining that a respective similarity between the first query and the set of related past queries and each cluster of queries does not satisfy a threshold; and
generating the updated text in response to determining that the respective similarity between the first query and the set of related past queries and each cluster of queries does not satisfy the threshold.

18. The method of claim 1, wherein the data related to the digital component comprises one or more of text depicted by the digital component, a description of the digital component, or text of a resource linked to be the digital component.

19. A system comprising:
one or more computers; and
one or more storage devices storing instructions that when executed by the one or more computers, cause the one or more computers to perform operations comprising:
receiving data indicating a first query received from a client device of a user;
obtaining an initial digital component (i) comprising a link to a first resource and (ii) depicting initial text related to the first resource;
obtaining search history data comprising a set of related past queries received from the user;
generating updated text related to the first resource by conditioning a language model with one or more contextual inputs that cause the language model to generate one or more outputs comprising the updated text, the one or more contextual inputs characterizing one or more of (i) the first query, (ii) data related to the initial digital component, (iii) the sequence of related past queries, or (iv) one or more tasks to be performed by the language model;
generating an updated digital component that depicts the updated text; and
providing, for display at the client device, the updated digital component depicting the updated text related to the first resource.

20. One or more computer-readable storage media storing instructions that, when executed by one or more computers, cause the one or more computers to perform operations comprising:
receiving data indicating a first query received from a client device of a user;
obtaining an initial digital component (i) comprising a link to a first resource and (ii) depicting initial text related to the first resource;
obtaining search history data comprising a set of related past queries received from the user;
generating updated text related to the first resource by conditioning a language model with one or more contextual inputs that cause the language model to generate one or more outputs comprising the updated text, the one or more contextual inputs characterizing one or more of (i) the first query, (ii) data related to the initial digital component, (iii) the sequence of related past queries, or (iv) one or more tasks to be performed by the language model;
generating an updated digital component that depicts the updated text; and
providing, for display at the client device, the updated digital component depicting the updated text related to the first resource.
